(19) United States
(12) Patent Application Publication
(10) Pub. No.: US 2018/0191831 A1
(43) Pub. Date: Jul. 5, 2018

(54) Facilitating Across-Network Handoffs for Devices Using Augmented Reality Display Devices

(71) Applicant: Bank of America Corporation, Charlotte, NC (US)

(72) Inventors: Cameron D. Wadley, Charlotte, NC (US); Joseph N. Johansen, Rock Hill, SC (US); Amanda J. Adams, Flint (GB); Kenneth A. Kaye, Indianapolis, IN (US)

(21) Appl. No.: 15/397,031

(22) Filed: Jan. 3, 2017

(51) Int. Cl. H04L 29/08; G06T 11/60; G06K 9/00; G06F 9/44; H04L 29/06

(52) U.S. Cl. CPC H04L 67/14; G06T 11/60; H04L 67/306; G06F 9/4446; H04L 67/38; G06K 9/00885

(57) ABSTRACT

An augmented reality system includes a first user device, a server, and an augmented reality user device. The first user device displays a virtual document during a first session and receives user input for the virtual document. The server stores session handoff information that includes the user input and location information indicating a location of the virtual document. The server generates a session handoff token using the session handoff information. The augmented reality user device receives the first session handoff token and generates a display based, at least in part, on the session handoff token.

### TECHNICAL FIELD

The present disclosure relates generally to performing operations using an augmented reality display device that overlays graphic objects with objects in a real scene.

### BACKGROUND

Users utilize user devices to initiate sessions. During a session, a user may require other participates to complete the session. For example, a second user may be used to provide additional context and/or additional information to complete the session. Conventional systems do not allow multiple users in physically distinct locations to view real-time modifications. In some embodiments, a user may use more than one user device to complete a session. Conventional systems do not allow seamless transitioning between user devices to continue a session.

### SUMMARY

In one embodiment, a first user initiates a session with an enterprise using a first augmented reality user device communicatively coupled to a server. The session may facilitate a transaction between at least the first user and the enterprise. The first augmented reality user device receives session information from the server. The session information includes first information sent by the first user and second information received by the first user during the session. The first augmented reality user device includes a display configured to overlay at least part of the session information onto a tangible object in real-time.

The server is further configured to generate an invitation token that includes an invitation for a second user to join the session. The invitation token includes the session information. A second augmented reality user device is communicatively coupled to the server and receives the invitation token and communicates an acceptance of the invitation to the server. The second augmented reality user device includes a display configured to overlay at least part of the session information onto a tangible object in real-time.

In another embodiment, a first user device displays a virtual document during a first session. The first user device receives user input from the first user device to facilitate completing the virtual document. The first user device receives a request from the first user to resume the session on a second user device.

A server stores handoff information. The handoff information includes the user input from the first session and location information associated with the virtual document and indicating a portion of the virtual document that the first user viewed prior to initiating the second session. The server generates a handoff token using the handoff information and communicates the handoff token to the second user device.

The second user device receives the session handoff token via a network interface. The second user device includes a display configured to overlay the virtual document on a tangible object in real-time using, at least in part, the session handoff token. The virtual document includes the user input and the display displays the information associated with the virtual document.

In yet another embodiment, a first user device displays a virtual document during a first session. A user provides user input to complete the virtual document. The first user device receives virtual assistant information from a virtual assistant. The virtual assistant information provides an overview of the virtual document and includes instructions to the user for providing user input to complete the virtual document.

The user requests to communicate with a live assistant. A server stores virtual handoff information. The virtual handoff information includes the input received from the user and a location of the virtual document viewed by the user before requesting a live assistant. The server generates a virtual handoff token using the virtual handoff information and communicates to the virtual handoff token to a second user device associated with the live assistant.

The live assistant views the information in the virtual handoff token and communicates with the user to provide instructions to the user to complete the virtual document.

The present disclosure presents several technical advantages. In one embodiment, one or more augmented reality user devices facilitate real-time, cross-network information retrieval and communication between a plurality of users. Conventional systems allow multiple users to revise electronic documents, but do not allow each user to view the revisions in real time. The unconventional approach contemplated in this disclosure allows a plurality of physically distinct users to participate in a session as thought the users are in the same physical location. For example, two users may be a party to a session to complete a transaction with an enterprise. The two users may be in physically separate locations. The augmented reality user devices may allow the users to participate in the session as though they are in the same physical location by allowing each user to communicate in real-time, view identical or substantially identical information in real-time, and view user input by one or more of the users as it is input in real-time. This unconventional solution leads to the technical advantage of providing real-time communication of information through a network.

In another embodiment, a server allows a user to seamlessly switch between a first user device and a second user device by generating a session handoff token using session handoff information. Conventional systems require a user to submit authentication information to resume a session using a second device. Furthermore, the user of a conventional system cannot resume the session at a suitable location after transitioning between devices. The unconventional solution to the technical problems inherent in conventional systems involve a server generating a session handoff token to allow a user to seamlessly transition between devices. For example, a user may initiate a first session using a first user device. The user may view information and provide user input in the first session. The user may navigate through the first session using the first user device. A server may dynamically receive and store session handoff information that includes the point to which the user navigated and the user input. A server allows the user to seamlessly switch the session to a second user device by tokenizing the session handoff information and communicating the information to the second user device.

In another embodiment, a user device provides cross-network information to a live assistant to facilitate assisting a user in real-time. Conventional systems are unable to provide real-time information to a live assistant. In the unconventional approach contemplated in this disclosure, a user initiates a session to facilitate completing a transaction. The user receives information for the session and provides user input to complete the session. A server dynamically receives the information and stores the information in real-time, in some embodiments. For example, the information includes information received by the user and input by the user. A user may request assistance from a live assistant. The live assistant may receive the information from the session from the server to facilitate assisting the user. This unconventional approach provides the technical advantage of transmitting real-time information to a live assistant through a network.

In another embodiment, an augmented reality device overlays contextual information in a real scene. Conventional systems cannot overlay contextual information in a real scene. For example, conventional systems are limited to providing information on a display. The unconventional approach utilizes augmented reality devices to overlay contextual information. The contextual information may be used to facilitate a transaction, such as receiving user input. In some embodiments, user input may be required to complete a virtual document. An augmented reality device is configured to overlay contextual information to facilitate providing the user input. For example, the augmented reality device may display the contextual information to a plurality of users. The users may view the contextual information in real-time and communicate to facilitate providing the user input. Overlaying information in a real scene reduces or eliminates the problem of being inadequately informed during an interaction. This unconventional approach provides the technical advantage of displaying contextual information in a real scene.

In yet another embodiment, an augmented reality user device employs identification tokens to allow data transfers to be executed using less information than other existing systems. By using less information to perform data transfers, the augmented reality user device reduces the amount of data that is communicated across the network. Reducing the amount of data that is communicated across the network improves the performance of the network by reducing the amount of time network resource are occupied. This unconventional approach reduces or eliminates network resource requirements. Inadequate network resources is a technical problem inherent in computer network technology.

The augmented reality user device generates identification tokens based on biometric data which improves the performance of the augmented reality user device by reducing the amount of information required to identify a person, authenticate the person, and facilitate a data transfer.

Identification tokens are encoded or encrypted to obfuscate and mask information being communicated across a network. Masking the information being communicated protects users and their information in the event of unauthorized access to the network and/or data occurs.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts in which:

FIG. 1 is a schematic diagram of an embodiment of an augmented reality system configured to facilitate dynamic location determination;

FIG. 2 is a first person view of an embodiment for a display;

FIG. 3 is a schematic diagram of an embodiment of an augmented reality user device employed by the augmented reality system;

FIG. 4 is a flowchart of an embodiment of a multiple user session performed by the system of FIG. 1;

FIG. 5 is a flowchart of an embodiment of a multiple user device handoff method performed by the system of FIG. 1; and

FIG. 6 is a flowchart of an embodiment of an assistant handoff method performed by the system of FIG. 1.

### DETAILED DESCRIPTION

Providing real-time, cross-network digital information communication for a session to complete a transaction presents several technical problems. A first user may initiate a session with an enterprise to facilitate a transaction. For example, the first user may provide user input to complete the transaction. The first user may request for a second user to join the session to provide advice, user input, and/or any other suitable type of information to facilitate completing the transaction. The conventional approach requires the first user and the second user to be in the same physical location to view dynamic, real-time information for the session.

This disclosure contemplates an unconventional approach to providing dynamic, real-time information. In the unconventional approach, a virtual reality system allows two users to participate in a session in real-time while located in two physically distinct locations by using augmented reality devices. A server receives real-time information for the session, including information displayed to each user and input provided by each user. The sever provides the real-time information to both the first user and the second user, allowing both users to view identical, or substantially identical, information in real time. This disclosure further recognizes the advantages of receiving input by either user and displaying the input to other users in real-time. The augmented reality user devices may allow each user to communicate in real-time as the users are viewing identical or substantially identical information in real-time, allowing the users to jointly participate in a session as if the users are in a same physical location.

Switching between a first user device and a second user device while seamlessly continuing a session presents several technical problems. A user may initiate a session using a first user advice. The user may provide information to a server and receive information from the server during a session. For example, a user may navigate through a virtual document and provide user input for the document. The conventional approach may allow a user to participate in a session, but if a user wishes to resume the session on a second user device, the user may be required to log into the session and navigate to through the virtual document to determine the location of the document where the first user ended the session.

The unconventional approach contemplated in this disclosure reduces or eliminates the technical problems associated with the conventional approach of transitioning between user devices. In this unconventional approach, a server dynamically receives information for a session to allow a user to seamlessly switch between user devices during a session. For example, the user device may dynamically receive user input from the user and information for the session indicating a point that the user reached. The user may indicate that he or she will continue the session on a second device. The server may use the received information to generate a token to communicate to a second device. The second user device may receive the token and generate a display using the token, allowing the user to resume the session on the second device with little or no user input. Generating the token provides the technical advantage of allowing a session to be device agnostic.

Receiving real-time, cross-network feedback for completing a transaction provides several technical challenges. A user may initiate a first session to complete a transaction. For example, the first session may include a virtual document that requires or requests input from the user. As the user is immersed in the session, the user may require assistance to continue. Conventional systems require a user to contact a live assistant, provide identifying information to the live assistant, and explain a problem that requires assistance. Providing identifying information and explaining a problem may require a substantial amount of time. Further, providing identifying information to a live assistant may allow an unauthorized user to gain access to a session.

The unconventional approach contemplated in this disclosure recognizes the technical advantages of a server that receives session information from the user and communicates the information to the assistant. The session information may include user input by the user during the session and information displayed to the user during the session. If the user requests assistance from a live assistant, the server automatically communicates the information to the live assistant. The assistant reviews the information and may immediately begin providing assistance to the user. This reduces or eliminates the need for the live assistant to receiving identifying information or gather additional information to begin assisting the user. This provides the technical advantage of automatically allowing a live assistant to assist a user by collecting session information in real-time and communicating the information to the live assistant. Generating a handoff token further increases the security of a session by requiring the user request the live assistant using the request assistance from the live assistant and generating a token in response to the request.

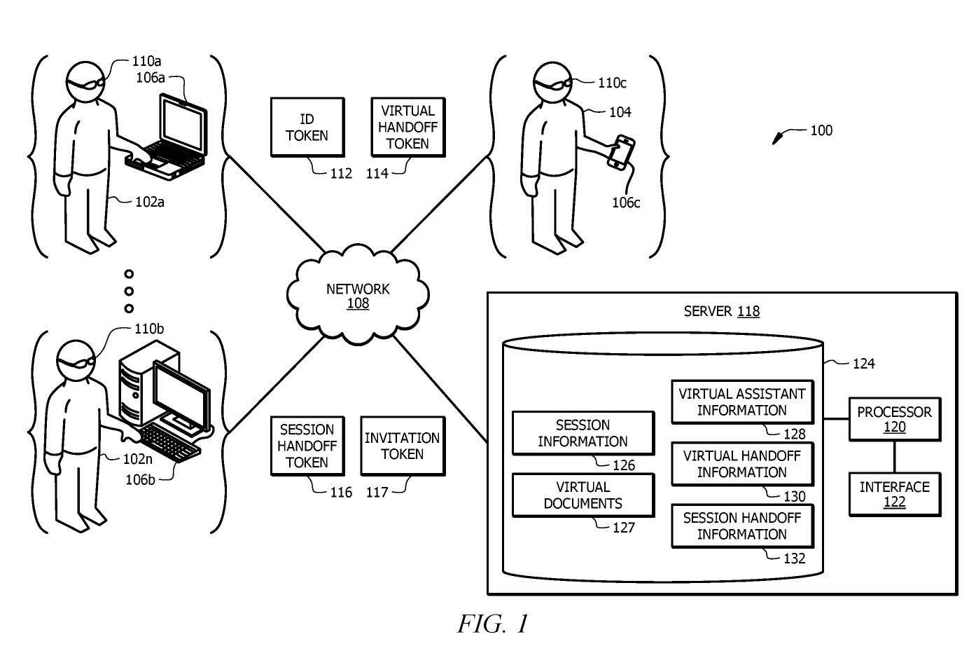

FIG. 1 illustrates an augmented reality system 100 configured to facilitate initiating and completing sessions, such as online sessions. As illustrated in FIG. 1, system 100 includes users 102, live assistant 104, user devices 106, network 108, augmented reality (“AR”) user devices 110, and server 118. User 102 may utilize system 100 to receive information from and provide information to server 118. Additional users 102 and/or live assistant 104 may assist in providing information to user 102 and/or server 118. In particular embodiments, system 100 allows users in physically separate geographically locations to view identical or similar information and communicate to complete tasks such as initiating and completing transactions.

System 100 may be utilized by user 102 and live assistant 104. System 100 may include any number of users 102 and live assistants 104. User 102 is generally a user of system 100 that receives information from and/or conducts business with an enterprise. For example, user 102 is an account holder, in some embodiments. A first user 102 may assist a second user 102 in performing a task, in some embodiments. For example, a second user 102b may be a parent or guardian of a first user 102a. In this example, user 102a may request user 102b to join a session to provide advice and/or guidance to user 102a during the session. User 102a may require assistance in gathering information during the session or to understand information asked during the session. User 102b may supply this information to user 102a. As another example, user 102b may be required to execute a document on behalf of user 102a, such as to cosign a document. As another example, user 102a and user 102b may be partners, such as business partners, a married couple, and/or any other suitable type of partners. User 102a and user 102b may complete a session together. For example, user 102a and user 102b may jointly complete an application such as a loan application.

Live assistant 104 generally assists and interacts with users 102. For example, live assistant 104 may be an employee of an enterprise. Live assistant 104 may interact with user 102 to aid user 102 in receiving information and/or completing tasks. In some embodiments, live assistant 104 may be a specialist. For example, live assistant 104 is an auto loan specialist, a retirement specialist, a home mortgage specialist, a business loan specialist, and/or any other type of specialist, in some embodiments. Although described as a user and live assistant, user 102 and live assistant 104 may be any suitable type of users that exchange information.

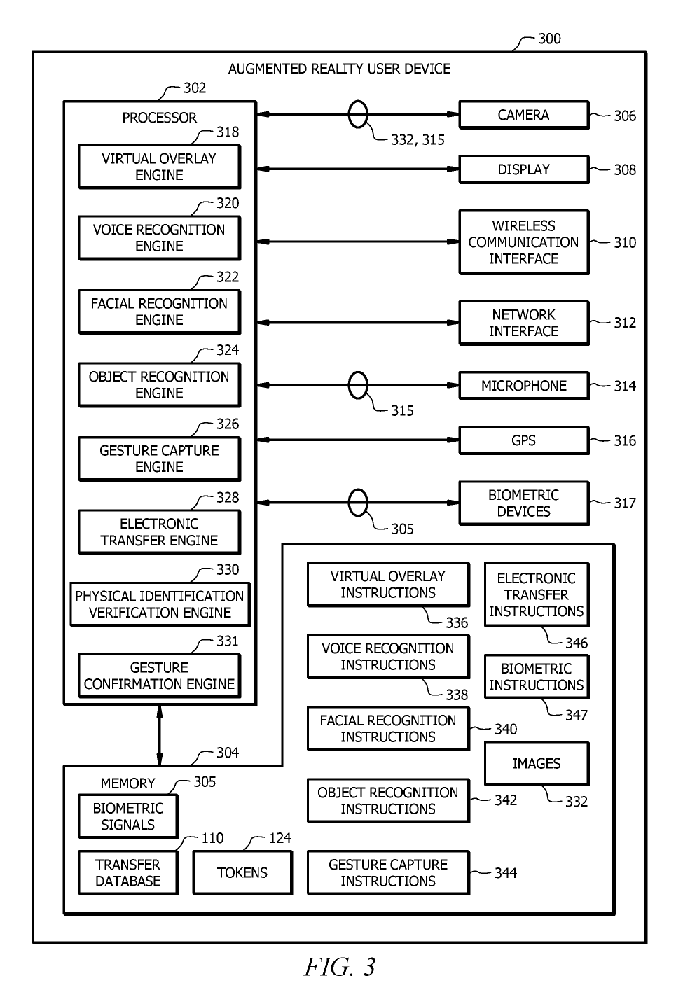

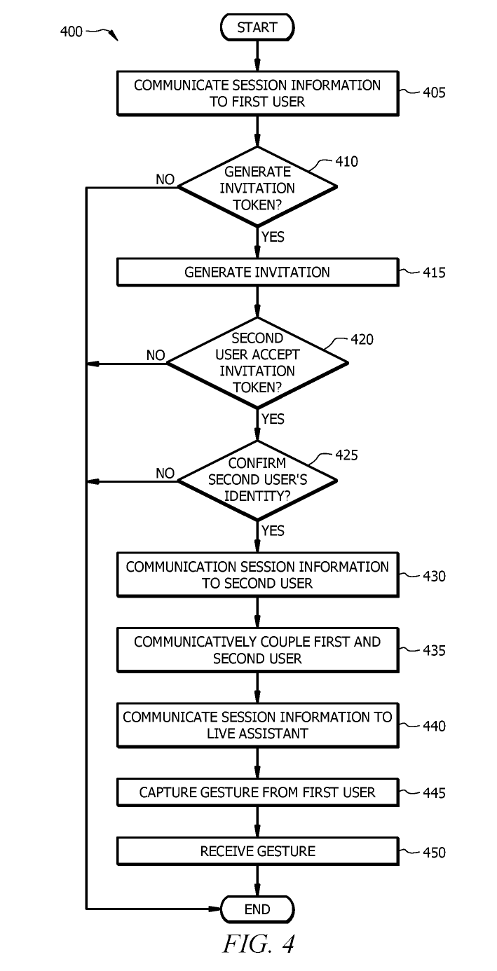

System 100 may comprise augmented reality (“AR”) user devices 110a, 110b, and 110c, associated with user 102a, user 102n, and live assistant 104, respectively. System 100 may include any number of AR user devices 110. For example, each user 102 and live assistant 104 may be associated with an AR user device 110. As yet another example, a plurality of users 102 and/or live assistants 104 may each use a single AR user device 110 or any number of AR user devices 110. In the illustrated embodiment, AR user device 110 is configured as a wearable device. For example, a wearable device is integrated into an eyeglass structure, a visor structure, a helmet structure, a contact lens, or any other suitable structure. In some embodiments, AR user device 110 may be or may be integrated with a mobile user device. Examples of mobile user devices include, but are not limited to, a mobile phone, a computer, a tablet computer, and a laptop computer. Additional details about AR user device 110 are described in FIG. 3. AR user device 110 is configured to confirm a user's identity using, e.g., a biometric scanner such as a retinal scanner, a fingerprint scanner, a voice recorder, and/or a camera. Examples of an augmented reality digital data transfer using AR user device 110 are described in more detail below and in FIGS. 4, 5, and 6.

AR user device 110 may include biometric scanners. For example, system 100 may verify live assistant 104's identity using AR user device 110 using one or more biometric scanners. As another example, system 100 may verify user 102's identity using AR user device 110 using one or more biometric scanners. AR user device 110 may comprise a retinal scanner, a fingerprint scanner, a voice recorder, and/or a camera. AR user device 110 may comprise any suitable type of device to gather biometric measurements. AR user device 110 uses biometric measurements received from the one or more biometric scanners to confirm a user's identity, such as user's 102 identity and/or employee's 104 identity. For example, AR user device may compare the received biometric measures to predetermined biometric measurements for a user.

In particular embodiments, AR user device 110 generates identity confirmation token 112. Identify confirmation token 112 generally facilitates transferring data through network 108. Identity confirmation token 112 is a label or descriptor used to uniquely identify a user. In some embodiments, identity confirmation token 112 includes biometric data for the user. AR user device 110 confirms user's 102 identity by receiving biometric data for user 102 and comparing the received biometric data to predetermined biometric data. AR user device 110 generates identity confirmation token 112 and may include identity confirmation token 112 in requests to server 118. In particular embodiments, identity confirmation token 112 is encoded or encrypted to obfuscate and mask information being communicated across network 108. Masking the information being communicated protects users and their information in the event of unauthorized access to the network and/or data occurs.

In the illustrated embodiment, system 100 includes user devices 106. System 100 may include any number of user devices 106. For example, each user 102 and live assistant 104 may be associated with a user device 106. As yet another example, a plurality of users 102 and/or live assistants 104 may each use a single user device 106 or any number of user devices 106. In some embodiments, one or more users 102 and/or user 104 may not be associated with a user device 106. This disclosure contemplates user device 106 being any appropriate device for sending and receiving communications over network 108. As an example and not by way of limitation, user device 106 may be a computer, a laptop, a wireless or cellular telephone, an electronic notebook, a personal digital assistant, a tablet, or any other device capable of receiving, processing, storing, and/or communicating information with other components of system 100. User device 106 may also include a user interface, such as a display, a microphone, keypad, or other appropriate terminal equipment. In some embodiments, an application executed by user device 106 may perform the functions described herein.

Network 108 facilitates communication between and amongst the various components of system 100. This disclosure contemplates network 108 being any suitable network operable to facilitate communication between the components of system 100. Network 108 may include any interconnecting system capable of transmitting audio, video, signals, data, messages, or any combination of the preceding. Network 108 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Server 118 generally receives information from and communicates information to AR user device 110 and user device 106. As illustrated, server 118 includes processor 120, memory 124, and interface 122. This disclosure contemplates processor 120, memory 124, and interface 122 being configured to perform any of the operations of server 118 described herein. Server 118 may be located remote to user 102 and/or live assistant 104.

Processor 120 is any electronic circuitry, including, but not limited to microprocessors, application specific integrated circuits (ASIC), application specific instruction set processor (ASIP), and/or state machines, that communicatively couples to memory 124 and interface 122 and controls the operation of server 118. Processor 120 may be 8-bit, 16-bit, 32-bit, 64-bit or of any other suitable architecture. Processor 120 may include an arithmetic logic unit (ALU) for performing arithmetic and logic operations, processor registers that supply operands to the ALU and store the results of ALU operations, and a control unit that fetches instructions from memory 124 and executes them by directing the coordinated operations of the ALU, registers and other components. Processor 120 may include other hardware and software that operates to control and process information. Processor 120 executes software stored on memory 124 to perform any of the functions described herein. Processor 120 controls the operation and administration of server 118 by processing information received from network 108, AR user device(s) 110, memory 124, and/or any other suitable component of system 100. Processor 120 may be a programmable logic device, a microcontroller, a microprocessor, any suitable processing device, or any suitable combination of the preceding. Processor 120 is not limited to a single processing device and may encompass multiple processing devices.

Interface 122 represents any suitable device operable to receive information from network 108, transmit information through network 108, perform suitable processing of the information, communicate to other devices, or any combination of the preceding. For example, interface 122 transmits data to AR user device 110. As another example, interface 110 receives information from AR user device 110. As a further example, interface 122 transmits data to—and receives data from—server 118. Interface 122 represents any port or connection, real or virtual, including any suitable hardware and/or software, including protocol conversion and data processing capabilities, to communicate through a LAN, WAN, or other communication systems that allows server 118 to exchange information with AR user devices 110, local server 126, and/or other components of system 100 via network 108.

Memory 124 may store, either permanently or temporarily, data, operational software, or other information for processor 120. Memory 124 may include any one or a combination of volatile or non-volatile local or remote devices suitable for storing information. For example, memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 124, a disk, a CD, or a flash drive. In particular embodiments, the software may include an application executable by processor 120 to perform one or more of the functions described herein. In particular embodiments, memory 124 may store session information 126, virtual documents 127, virtual assistant information 128, virtual handoff information 130, session handoff information 132, and/or any other suitable information. This disclosure contemplates memory 124 storing any of the elements stored in AR user device 110, user device 106, and/or any other suitable components of system 100.

Session information 126 generally includes information for a session. Session information 126 includes information provided by user 102 in a session, information received by user 102 in a session, and user's 102 progress in completing a task during a session. Session information may be associated with virtual documents 127 to be completed by one or more users 102, such as a mortgage application document, an auto loan application document, a deposit request document, a withdrawal authorization document, and/or any other suitable type of document. In some embodiments, user 102 may access server 118 to initiate a session to complete a virtual document 127. For example, user 102 may complete a deposit request document. In this example, session information 126 includes information for the account deposit. For example, user 102 may supply an account and a deposit amount. Session information 126 may indicate the account and deposit amount. Session information 126 may indicate, in this example, that user 102 did not indicate a deposit source. Thus, session information may include information provided by user 102, information received by user 102, user's 102 progress in completing a task in a session, and/or any other suitable information. For example, user 102 may have navigated through one or more electronic pages and/or screens in the first session, and session information 126 may identify a point to which user 102 navigated.

Session information 126 may include information for accounts of user 102. User 102 may have one or more accounts with an enterprise. Session information 126 may indicate a type of account, an account balance, account activity, personal information associated with user 102, and/or any other suitable type of account information. For example, user 102 may have a checking account. Session information 126 may identify the checking account. Session information 126 may comprise a balance for the account, credits and/or debits of the account, a debit card associated with the account, and/or any other suitable information. As another example, session information 126 may identify a retirement account associated with user 102. In this example, session information 126 may include a balance for the account, account assets, account balances, user's 102 age, user's 102 preferred retirement age, and/or any other suitable type of information. User 102 may be associated with any number of accounts. User 102 may not be associated with any accounts.

Server 118 may use session information 126 to generate invitation token 117. Invitation token 117 generally facilitates transferring data through network 108. Invitation token 117 generally includes information to facilitate inviting additional users to a session with a first user. In some embodiments, invitation token 117 includes all or part of information 126. In some embodiments, session handoff token 116 includes an identification of a second user. In particular embodiments, invitation token 117 is encoded or encrypted to obfuscate and mask information being communicated across network 108. Masking the information being communicated protects users and their information in the event of unauthorized access to the network and/or data occurs.

Virtual documents 127 are generally documents displayed to user 102 during a session. Virtual documents 127 may provide information to user 102. For example, virtual documents may include account information 126. In some embodiments, user 102 may provide user input to complete a virtual document 127 to facilitate a request or other transaction. For example, user 102 may complete a virtual document 127 to request a mortgage, an auto loan, an account withdrawal, an account deposit, an account transfer or any other suitable type of request. A virtual document 127 may be a loan application, a deposit request form, a transfer request form, a withdrawal authorization form, and/or any other suitable type of document. Although described as a document, virtual documents 127 may be any form of information and/or request for input displayed by user device 106 and/or AR user device 110. While described as a virtual document, virtual document 127 may be any display of information and/or display that accepts user input.

Virtual assistant information 128 generally comprises instructions to facilitate completing a task in a session. For example, user 102 may provide input to a virtual document 127 such as an application or an authorization during a session. Virtual assistant information 128 may include document overview information to facilitate providing an overview of the virtual document. For example, virtual assistant information 128 may include information for the contents of the virtual document, the requirements of the virtual document, the expected inputs of the virtual document, who views the document, a deadline for the document, and/or or any other suitable information for a virtual document 127. As another example, virtual assistant information 128 may include input information to facilitate providing instructions for providing inputs for the virtual document 127. As an example, a virtual document 127 may request that user 102 input a name in the virtual document. Virtual assistant information 128 may include information to instruct user 102 to provide a full legal name in the document. AR user device 110 may display virtual assistant information 128 to facilitate user 102 completing a virtual document or facilitating any other suitable type of transaction that may require assistance and/or instructions.

Virtual handoff information 130 generally includes information to facilitate providing live assistant 104 with information to assist user 102 in a session. Virtual handoff information 130 may include information provided to user 102 using virtual assistant information 128, input provided by user 102 in a session, one or more virtual documents 127 viewed by user 102, and user's 102 progress in completing a task during a session. In some embodiments, virtual assistant information 128 may include all or part of session information 126 and/or virtual assistant information 128. User 102 may access server 118 using, e.g., AR user device 110 and/or user device 106. User 102 may access server 118 to provide information to server 118 and/or receive information from server 118. For example, user 102 may access server 118 to initiate a session to complete a virtual document 127. During this session user 102 may receive information from a virtual assistant using virtual assistant information 128. User 102 may request to communicate with live assistant 104 at a period of time after initiating a session. Virtual handoff information allows live assistant 104 to view information to the session to assist user 102 more accurately and efficiently.

In particular embodiments, server 118 generates virtual handoff token 114 to communicate to live assistant 104. Virtual handoff token 114 generally facilitates transferring data through network 108. Virtual handoff token 114 may include virtual handoff information 130. Virtual handoff token 114 may include any information that allows live assistant 104 to assist user 102. In some embodiments, virtual handoff token may identify live assistant 104. In particular embodiments, virtual handoff token 114 is encoded or encrypted to obfuscate and mask information being communicated across a network. Masking the information being communicated protects users and their information in the event of unauthorized access to the network and/or data occurs.

Session handoff information 132 generally comprises information to facilitate handing off a session from a first device to a second device. Session handoff information 132 comprises information for a session of user 102. For example, session handoff information 132 may include session information 126, virtual documents 127, virtual assistant information 128, and/or any other suitable type of information. In some embodiments, session handoff information 132 may include identical information as virtual handoff information 130.

Server 118 may use session handoff information 132 to generate session handoff token 116. Session handoff token 132 generally facilitates transferring data through network 108. Session handoff information 132 generally includes information to handoff a session from a first user device 106 or first AR user device 110 to a second user device 106 or second AR user device 110. In some embodiments, session handoff token 116 includes all of part of session handoff information 132, session information 126 and/or virtual documents 127. In some embodiments, session handoff token 116 includes an identification of a first device and/or a second device. In particular embodiments, session handoff token 116 is encoded or encrypted to obfuscate and mask information being communicated across network 108. Masking the information being communicated protects users and their information in the event of unauthorized access to the network and/or data occurs.

In a first example embodiment of operation, system 100 facilitates allowing multiple users 102 to participate in a session using system 100. In this example embodiment, a first user 102a uses AR user device 110a to initiate a session using server 118. For example, user 102a logs into landing page to access an online account to initiate a first session. User 102a initiates a session using the online account page. For example, user 102a may initiate a session to begin or resume an application, to make an account deposit, to make an account withdraw, to formulate a retirement plan, and/or to perform any other suitable task. Server 118 communicates session information 126 to AR user device 110a, and AR user device 110a uses a display to overlay session information 126 onto a tangible object in real time for user 102a. For example, AR user device may present a virtual document 127 for user 102a to complete such as an application document or an account withdrawal request document.

User 102a may utilize AR user device 110a and/or user device 106a to interact with server 118 during the session. For example, user 102a may utilize AR user device 110a to provide information to complete virtual document 127. User 102a may require an additional user, e.g., user 102b, during the session.

User 102a may use AR user device 110a to generate a request to add user 102b to the session. For example, user 102b may facilitate completing a task in the session such as providing advice or information to user 102a and/or signing a document. For example, the request may be for AR user device 110b associated with user 102b to display the virtual document 127 for user 102b. AR user device 110a communicates the request to server 118, and server 118 generates an invitation. For example, server 118 generates an invitation token 117 and communicates the invitation token 117 to AR user device 110b associated with user 102b. In some embodiments, server 118 generates an invitation token 117 prior to a session. For example, user 102a may schedule a session and communicate a session token to user 102b before the session begins.

AR user device 110b may confirm user's 102b identity in response to receiving the information. AR user device 110b receives biometric data from user 102b. For example, AR user device 110b may utilize a fingerprint scanner, a retinal scanner, a voice recorder, a camera, or any other sort of biometric device to receive biometric data for user 102b. The biometric data is compared to predetermined biometric data for user 102b to confirm user's 102b identity. AR user device 110b may generate identification token 112 in response to confirming user's 102b identity.

User 102b may accept the invitation from central server 118 and communicates the acceptance to central server 118, along with identification token 112. Server 118 communicates session information 126 to user 102b in response to the acceptance. In some embodiments, AR user device 110a and AR user device 110b display identical information. For example, user 102a and user 102b may view the same virtual document.

AR user device 110a and AR user device 110b are communicatively coupled when user 102a and user 102b are in the same session to allow user 102a and user 102b to communicate. For example, AR user device 110a/110b may include a microphone and a speaker, allowing user 102a and user 102b to communicate orally. AR user device 110a may include a camera to allow user 102a and user 102b to communicate visually via a display.

AR user device 110a/110b may be configured to recognize gestures from user 102a and user 102b, respectively. For example, users 102a and user 102b may sign or otherwise execute a virtual document. The users 102 may execute a document to complete an application, to approve an account withdrawal, or to initiate or complete any other suitable task. AR user device 110 may capture a gesture using a camera, a stylus, a data glove, and/or any other suitable type of device.

Live assistant 104 utilizes AR user device 110c to participate in the session, in some embodiments. AR user device 110c receives session information from server 118 and displays session information 118 by generating an overlay onto a tangible object in real-time. AR user device 110c is communicatively coupled to AR user device 110a and/or AR user device 110b, allowing live assistant 104 to communicate with user 102a and/or user 102b. Live assistant 104 may provide information for completing a session, such as information on how to complete a virtual document.

In this example embodiment, user 102a and user 102b, while being physically separate, may participate in an interaction as though they are each within the same physical space. The users 102 may apply for a loan application or complete any other type of request or transaction by viewing the same information at the same time while communicating with each other. This provides the technical advantage of allowing users to interact to complete tasks while being physically separate.

In a second example embodiment of operation, system 100 facilitates seamlessly transitioning between two or more devices during a session. In this example embodiment, user 102 initiates a first session using user device 106. For example, user 102 logs onto a landing page using a laptop computer to initiate the first session. The first session may be to generate a request for a loan. Once user 102 initiates the first session, user device 106 displays a virtual document 127 for user 102. For example, the virtual document 127 may be a loan application. User 102 provides user input to begin completing the virtual document 127. In some embodiments, AR user device 110 and/or user device 106 may display virtual assistant information for user 102 to provide additional information and/or instructions for viewing and/or completing a virtual document 127 in the session. As user 102 is completing the virtual document, user 102 may request to continue the session using AR user device 110.

User device 106 receives the request and communicates the request to switch devices to server 118. Server 118 receives the request and generates session handoff token 116 using session information 126 that includes the input provided by user 102 in the first session and the portion of virtual document 127 that user 102 was viewing when user 102 requested the session information. Server 118 communicates session handoff token 116 to AR user device 110.

AR user device 110 receives session handoff token 116 and confirms user's 102 identity in response to receiving session handoff token 116. For example, AR user device 110 receives biometric data for user 102 and compares the received biometric data for user 102 to predetermined biometric data for user 102. AR user device 110 may receive the biometric data using at least one of a retinal scanner, a fingerprint scanner, a voice recorder, and a camera. AR user device 110 generates identification token 112 for user 102 and communicates identification token 112 to server 118. Server 118 continues the session in response to receiving identification token 112 for user 102.

AR user device 110 generates a virtual overlay that includes the one or more virtual documents 127 associated with the first session of user 102. The virtual document 127 includes the input provided by user 102 during the first session and AR user device 110 displays, in the second session, the portion of virtual document 127 that user 102 was viewing on user device 106 before initiating the second session. Thus, system 100 allows user 102 to seamlessly transition between user device 106 and AR user device 110 to view and/or complete virtual documents 127.

User 102 may provide additional input to AR user device 110 to continue completing virtual document 127 in the session using AR user device 110. AR user device 110 communicates the additional user input to server 118. In some embodiments, AR user device 110 (and also user device 106) communicates user input to server 118 dynamically as user 102 inputs information.

User 102 may request to switch back to the first user device 106 or to any other user device 106/AR user device 110. AR user device 110 communicates the request to server 118. Server 118 generates a second session handoff token 116 in response to the request. The second session handoff token includes the additional user input from user 102, a location of virtual document 127 that user 102 viewed before making the request, and the first user input. Server 118 communicates the session handoff token 116 to user device 106. User device 106 continues the session, allowing user 102 to seamlessly continue to review and/or complete a virtual document 127 using user device 106.

In a third example embodiment of operation, system 100 facilitates system 100 handing off a session from a virtual assistant to a live assistant. In this example embodiment, user 102 initiates a first session using AR user device 110 and/or user device 106. For example, user 102 may use a landing page to log into an online portal to initiate a session. In another example, user 102 may initiate a session via a telephone. The session may be to receive information from and enterprise and/or provide information to an enterprise. In some embodiments, user 102 may provide information to complete a virtual document 127. User 102 may use AR user device 110 and/or user device 106 to provide input for the virtual document 127. For example, user 102 may use a telephone keypad, a computer keyboard, voice commands, gestures, or any other suitable type of input to provide information to complete virtual document 127.

A virtual assistant may provide information to user 102 during the session. The virtual assistant may use virtual assistant information 128 to provide information to user 102, in some embodiments. For example, the virtual assistant may provide information to user 102 to facilitate receiving input from user 102. During the session, user 102 may be required to provide information. For example, if user 102 is completing a loan application, user 102 may be required to provide income information. Virtual assistant may provide information for what qualifies as income, in this example. Virtual assistant may provide this information via voice, text, video, and/or any other suitable means of communicating information to user 102 using virtual assistant information 128. User 102 may provide input during the first session to provide information to server 118 (e.g., to provide input to complete a virtual document 127).

User 102 may request to communicate with live assistant 104. User 102 may require assistance. For example, user 102 may require assistance in providing requested user input (e.g., user input for completing a virtual document 127) and/or understanding information received from server 118. User 102 may determine that the virtual assistant using virtual assistant information 128 is inadequate and request live assistant 104.

Server 118 receives the request for live assistant 104 and generates virtual handoff token 114 in response to the request. As previously discussed, virtual handoff token 114 may include information to provide live assistant 104 context and information for assisting user 102. For example, virtual handoff token 114 may include virtual handoff information 130. Server 118 communicates virtual handoff token 114 to live assistant 104 via AR user device 110c and/or user device 106c. Live assistant 104 views information from virtual handoff token 104 to review information for user's 102 session. For example, live assistant 104 may determine a task that user 102 is attempting to complete, information received by user 102, information provided by user 102, a virtual document 127 associated with the session, and/or any other suitable type of information that facilitates assistant user 102.

Live assistant 104 may communicate with user 102 to provide assistance or any other type of information to user 102. In some embodiments, AR user device 110a/110c and/or user device 106a/106c are equipped with a microphone and a speaker to allows user 102 and virtual assistant 104 to communicate orally. The devices may be equipped with a camera to facilitate user 102 and virtual assistant 104 to communicate visually. In some embodiments, live assistant 102 and 104 may provide and receive textual input (e.g., typing on a keyboard) to communicate with each other. In some embodiments, user 102 and live assistant 104 may both utilize AR user device 110a and 110c, respectively. In this embodiment, AR user devices 110a/110c may generate an identical display for user 102 and virtual assistant 104. The display may include a virtual document 127 that user 102 is completing. This allows user 102 and virtual assistant 104 to view the virtual document 127 to facilitate communications regarding the virtual document 127.

Modifications, additions, or omissions may be made to system 100 without departing from the scope of the invention. For example, system 100 may include any number of processors 120, memories 124, AR user devices 110, and/or servers 118. As a further example, components of system 100 may be separated or combined. For example, server 118 and AR user device 110 may be combined.

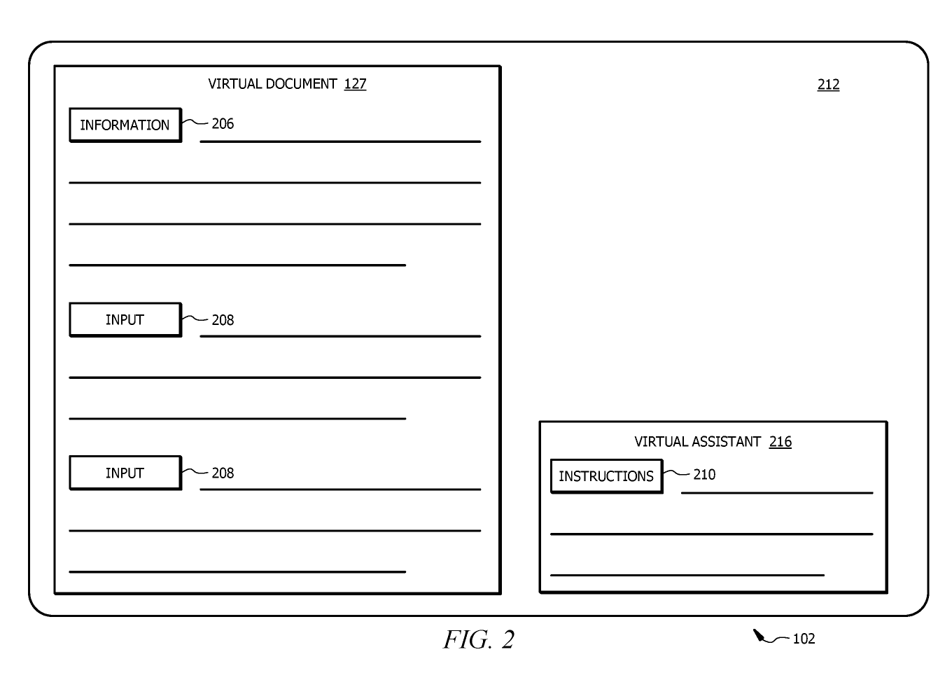

FIG. 2 is a first person view 200 of a display 200 of AR user device 110 and/or user device 106. In some embodiments, user 102 views first person view 200 using AR user device 110. In some embodiments, a first user 102a, a second user 102b, and/or live assistant 104 view first person view 200 at the same time from different devices.

First person view 200 may comprise virtual document 127. Virtual document 127 may be a virtual overlay in real scene 127. Generally, virtual document 127 is used to provide information to user 102 and/or to facilitate completing a request or any other sort of transaction. As previously discussed, virtual document 127 may be an application such as a mortgage application or an auto loan application. As another example, virtual document 127 may be a deposit request or a withdrawal authorization. Virtual document 127 may include information 206. In some embodiments, information 206 is part of session information 126. Information 206 may provide information for a transaction. For example, when virtual document 127 is a loan application, information 206 may include information for the loan such as loan terms, information for one or more users 102, and/or any other suitable type of loan information. Information 206 may include any type of information stored as session information 126, virtual documents 127, and/or any other suitable type of information.

Virtual document 127 may require or request input 208 from one or more users 102. For example, one or more users 102 may provide user input to complete input 208. Users 102 may provide user input that is stored as input 208. In the embodiment where virtual document 127 is a withdrawal authorization document, input 208 may require one or more users 102 to provide a signature. Input 208 is received from user 102 and stored as session information 126, in some embodiments.

First person view 200 may include virtual assistant 210. Virtual assistant 210 generally provides information 210 for virtual document 127. In an embodiment, instructions 210 are all or a subset of virtual assistant information 128. For example, instructions 210 may provide an overview of virtual document 127. As another example, instructions 210 may provide a summary of information 206. As yet another example, instructions 210 may provide instructions for inputting information to satisfy input 208. In the example where input 208 is a signature requirement, instructions 210 may provide instructions to one or more users 102 to provide a signature and instructions on how to provide a signature for virtual document 127.

FIG. 3 illustrates an augmented reality user device employed by the augmented reality system 100, in particular embodiments. AR user device 110 may be configured to confirm user 102's and/or live assistant 104's identity and receive and display information.

AR user device 110 comprises a processor 302, a memory 304, a camera 306, a display 308, a wireless communication interface 310, a network interface 312, a microphone 314, a global position system (GPS) sensor 316, and one or more biometric devices 317. The AR user device 110 may be configured as shown or in any other suitable configuration. For example, AR user device 110 may comprise one or more additional components and/or one or more shown components may be omitted.

Examples of the camera 306 include, but are not limited to, charge-coupled device (CCD) cameras and complementary metal-oxide semiconductor (CMOS) cameras. The camera 306 is configured to capture images 332 of people, text, and objects within a real environment. The camera 306 may be configured to capture images 332 continuously, at predetermined intervals, or on-demand. For example, the camera 306 may be configured to receive a command from a user to capture an image 332. In another example, the camera 306 is configured to continuously capture images 332 to form a video stream of images 332. The camera 306 may be operably coupled to a facial recognition engine 322 and/or object recognition engine 324 and provides images 332 to the facial recognition engine 322 and/or the object recognition engine 324 for processing, for example, to identify people, text, and/or objects in front of the user. Facial recognition engine 322 may confirm a user's 102 identity.

The display 308 is configured to present visual information to a user in an augmented reality environment that overlays virtual or graphical objects onto tangible objects in a real scene in real-time. In an embodiment, the display 308 is a wearable optical head-mounted display configured to reflect projected images and allows a user to see through the display. For example, the display 308 may comprise display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matrix OLED (AMOLED), an organic LED (OLED) display, a projector display, or any other suitable type of display as would be appreciated by one of ordinary skill in the art upon viewing this disclosure. In another embodiment, the display 308 is a graphical display on a user device. For example, the graphical display may be the display of a tablet or smart phone configured to display an augmented reality environment with virtual or graphical objects overlaid onto tangible objects in a real scene in real-time.

Examples of the wireless communication interface 310 include, but are not limited to, a Bluetooth interface, an RFID interface, an NFC interface, a local area network (LAN) interface, a personal area network (PAN) interface, a wide area network (WAN) interface, a Wi-Fi interface, a ZigBee interface, or any other suitable wireless communication interface as would be appreciated by one of ordinary skill in the art upon viewing this disclosure. The wireless communication interface 310 is configured to allow the processor 302 to communicate with other devices. For example, the wireless communication interface 310 is configured to allow the processor 302 to send and receive signals with other devices for the user (e.g. a mobile phone) and/or with devices for other people. The wireless communication interface 310 is configured to employ any suitable communication protocol.

The network interface 312 is configured to enable wired and/or wireless communications and to communicate data through a network, system, and/or domain. For example, the network interface 312 is configured for communication with a modem, a switch, a router, a bridge, a server, or a client. The processor 302 is configured to receive data using network interface 312 from a network or a remote source.

Microphone 314 is configured to capture audio signals (e.g. voice signals or commands) from a user and/or other people near the user. The microphone 314 is configured to capture audio signals continuously, at predetermined intervals, or on-demand. The microphone 314 is operably coupled to the voice recognition engine 320 and provides captured audio signals to the voice recognition engine 320 for processing, for example, to identify a voice command from the user.

The GPS sensor 316 is configured to capture and to provide geographical location information. For example, the GPS sensor 316 is configured to provide the geographic location of a user employing the augmented reality user device 300. The GPS sensor 316 is configured to provide the geographic location information as a relative geographic location or an absolute geographic location. The GPS sensor 316 provides the geographic location information using geographic coordinates (i.e. longitude and latitude) or any other suitable coordinate system.

Examples of biometric devices 317 include, but are not limited to, retina scanners, finger print scanners, voice recorders, and cameras. Biometric devices 317 are configured to capture information about a person's physical characteristics and to output a biometric signal 305 based on captured information. A biometric signal 305 is a signal that is uniquely linked to a person based on their physical characteristics. For example, a biometric device 317 may be configured to perform a retinal scan of the user's eye and to generate a biometric signal 305 for the user based on the retinal scan. As another example, a biometric device 317 is configured to perform a fingerprint scan of the user's finger and to generate a biometric signal 305 for the user based on the fingerprint scan. The biometric signal 305 is used by a physical identification verification engine 330 to identify and/or authenticate a person. The processor 302 is implemented as one or more CPU chips, logic units, cores (e.g. a multi-core processor), FPGAs, ASICs, or DSPs. The processor 302 is communicatively coupled to and in signal communication with the memory 304, the camera 306, the display 308, the wireless communication interface 310, the network interface 312, the microphone 314, the GPS sensor 316, and the biometric devices 317. The processor 302 is configured to receive and transmit electrical signals among one or more of the memory 304, the camera 306, the display 308, the wireless communication interface 310, the network interface 312, the microphone 314, the GPS sensor 316, and the biometric devices 317. The electrical signals are used to send and receive data (e.g. images 232 and transfer tokens 124) and/or to control or communicate with other devices. For example, the processor 302 transmits electrical signals to operate the camera 306. The processor 302 may be operably coupled to one or more other devices (not shown).

The processor 302 is configured to process data and may be implemented in hardware or software. The processor 302 is configured to implement various instructions. For example, the processor 302 is configured to implement a virtual overlay engine 318, a voice recognition engine 320, a facial recognition engine 322, an object recognition engine 324, a gesture capture engine 326, an electronic transfer engine 328, a physical identification verification engine 330, and a gesture confirmation engine 331. In an embodiment, the virtual overlay engine 318, the voice recognition engine 320, the facial recognition engine 322, the object recognition engine 324, the gesture capture engine 326, the electronic transfer engine 328, the physical identification verification engine 330, and the gesture confirmation engine 331 is implemented using logic units, FPGAs, ASICs, DSPs, or any other suitable hardware.

The virtual overlay engine 318 is configured to overlay virtual objects onto tangible objects in a real scene using the display 308. For example, the display 308 may be a head-mounted display that allows a user to simultaneously view tangible objects in a real scene and virtual objects. The virtual overlay engine 318 is configured to process data to be presented to a user as an augmented reality virtual object on the display 308. An example of overlay virtual objects onto tangible objects in a real scene is shown in FIG. 1.

The voice recognition engine 320 is configured to capture and/or identify voice patterns using the microphone 314. For example, the voice recognition engine 320 is configured to capture a voice signal from a person and to compare the captured voice signal to known voice patterns or commands to identify the person and/or commands provided by the person. For instance, the voice recognition engine 320 is configured to receive a voice signal to authenticate a user and/or another person or to initiate a digital data transfer.

The facial recognition engine 322 is configured to identify people or faces of people using images 332 or video streams created from a series of images 332. In one embodiment, the facial recognition engine 322 is configured to perform facial recognition on an image 332 captured by the camera 306 to identify the faces of one or more people in the captured image 332. In another embodiment, the facial recognition engine 322 is configured to perform facial recognition in about real-time on a video stream captured by the camera 306. For example, the facial recognition engine 322 is configured to continuously perform facial recognition on people in a real scene when the camera 306 is configured to continuous capture images 332 from the real scene. The facial recognition engine 322 employs any suitable technique for implementing facial recognition as would be appreciated by one of ordinary skill in the art upon viewing this disclosure.

The object recognition engine 324 is configured to identify objects, object features, text, and/or logos using images 332 or video streams created from a series of images 332. In one embodiment, the object recognition engine 324 is configured to identify objects and/or text within an image 332 captured by the camera 306. In another embodiment, the object recognition engine 324 is configured to identify objects and/or text in about real-time on a video stream captured by the camera 306 when the camera 306 is configured to continuously capture images 332. The object recognition engine 324 employs any suitable technique for implementing object and/or text recognition as would be appreciated by one of ordinary skill in the art upon viewing this disclosure.

The gesture recognition engine 326 is configured to identify gestures performed by a user and/or other people. Examples of gestures include, but are not limited to, hand movements, hand positions, finger movements, head movements, audible gestures, and/or any other actions that provide a signal from a person. For example, gesture recognition engine 326 is configured to identify hand gestures provided by a user 105 to indicate that the user 105 executed a document. For example, the hand gesture may be a signing gesture associated with a stylus, a camera, and/or a data glove. As another example, the gesture recognition engine 326 is configured to identify an audible gesture from a user 105 that indicates that the user 105 executed virtual file document 120. The gesture recognition engine 326 employs any suitable technique for implementing gesture recognition as would be appreciated by one of ordinary skill in the art upon viewing this disclosure.

The physical identification verification engine 330 is configured to identify a person based on a biometric signal 305 generated from the person's physical characteristics. The physical identification verification engine 330 employs one or more biometric devices 317 to identify a user based on one or more biometric signals 305. For example, the physical identification verification engine 330 receives a biometric signal 305 from the biometric device 317 in response to a retinal scan of the user's eye, a fingerprint scan of the user's finger, an audible voice capture, and/or a facial image capture. The physical identification verification engine 330 compares biometric signals 305 from the biometric device 317 to previously stored biometric signals 305 for the user to authenticate the user. The physical identification verification engine 330 authenticates the user when the biometric signals 305 from the biometric devices 317 substantially matches (e.g. is the same as) the previously stored biometric signals 305 for the user. In some embodiments, physical identification verification engine 330 includes voice recognitions engine 320 and/or facial recognition engine 322.

Gesture confirmation engine 331 is configured to receive a signor identity confirmation token, communicate a signor identity confirmation token, and display the gesture motion from the signor. Gesture confirmation engine 331 may facilitate allowing a witness, such as a notary public or an uninterested witness, to confirm that the signor executed the document. Gesture engine 331 may instruct AR user device 110 to display the signor's digital signature 135 on virtual file document 120. Gesture confirmation engine 331 may instruct AR user device 110 to display the gesture motion from the signor in any suitable way including displaying via audio, displaying via an image such as video or a still image, or displaying via virtual overlay.

The memory 304 comprises one or more disks, tape drives, or solid-state drives, and may be used as an over-flow data storage device, to store programs when such programs are selected for execution, and to store instructions and data that are read during program execution. The memory 304 may be volatile or non-volatile and may comprise ROM, RAM, TCAM, DRAM, and SRAM. The memory 304 is operable to store transfer tokens 125, biometric signals 305, virtual overlay instructions 336, voice recognition instructions 338, facial recognition instructions 340, object recognition instructions 342, gesture recognition instructions 344, electronic transfer instructions 346, biometric instructions 347, and any other data or instructions.

Biometric signals 305 are signals or data that is generated by a biometric device 317 based on a person's physical characteristics. Biometric signal 305 are used by the AR user device 110 to identify and/or authenticate an AR user device 110 user by comparing biometric signals 305 captured by the biometric devices 317 with previously stored biometric signals 305.

Transfer tokens 125 are received by AR user device 110. Transfer tokens 125 may include identification tokens 112, virtual handoff tokens 114, session handoff tokens 116, or any other suitable types of tokens. In particular embodiments, transfer tokens 125 are encoded or encrypted to obfuscate and mask information being communicated across a network. Masking the information being communicated protects users and their information in the event of unauthorized access to the network and/or data occurs.

The virtual overlay instructions 336, the voice recognition instructions 338, the facial recognition instructions 340, the object recognition instructions 342, the gesture recognition instructions 344, the electronic transfer instructions 346, and the biometric instructions 347 each comprise any suitable set of instructions, logic, rules, or code operable to execute virtual overlay engine 318, the voice recognition engine 320, the facial recognition engine 322, the object recognition engine 324, the gesture recognition capture 326, the electronic transfer engine 328, and the physical identification verification engine 330, respectively.

FIG. 4 is an example method 400 of multiple user session method performed by system 100. In some embodiments, one or more users 102 utilizes system 100 to perform method 400. The method begins at step 405 where server 118 communicates session information to a first user 102a via AR user device 110a. AR user device 110a displays all or part of session information 126 to user 102a by generating a virtual overlay. System 100 determines whether to generate an invitation token 117 at step 410. For example, user 102a may submit a request to invite user 102b to participate in the session. If system 100 does not generate a session token, method 400 ends. Otherwise method 400 proceeds to step 415 where server 118 generates an invitation token 117 and communicates the invitation token 117 to user 102b via AR user device 110b.

System 100 determines if user 102b accepts the invitation at step 420. If user 102b does not accept the invitation to join the session with user 102b, the method ends. If user 102b does accept the invitation, AR user device 110b confirms user's 102b identity at step 425. For example, AR user device 110b may receive biometric data for user 102b and compare the received biometric data to predetermined biometric data for user 102b. If system 100 does not confirm user's 102b identity, method 400 ends. Otherwise, the method proceeds to step 430 where server 118 communicates session information 126 to AR user device 110b in response to receiving user's 102b acceptance. AR user devices 110a and 100b are communicatively coupled at step 435, allowing user 102a and user 102b to communicate. For example, user 102a and user 102b may communicate orally and/or visually.

Server 118 communicates session information 126 to live assistant 104 via AR user device 110c at step 440. Live assistant 104 may view session information 126 to provide assistant to user 102a and/or user 102b. For example, live assistant 104 may provide advice for completing a session such as completing a virtual document 127.

System 100 captures a gesture from user 102a via AR user device 110a at step 445. For example, user 102a may sign or otherwise execute a virtual document. AR user device 110a may capture the gesture and communicate the gesture to server 118 at step 450. Server 118 may include the gesture as session information 126, where it is displayed to user 102a, user 102b, and live assistant 104 via each user's respective AR user device 110.

Modifications, additions, or omissions may be made to method 400 depicted in FIG. 4. Method 400 may include more, fewer, or other steps. For example, steps may be performed in parallel or in any suitable order. While discussed as specific components completing the steps of method 400, any suitable any suitable component of system 100 may perform any step of method 400.

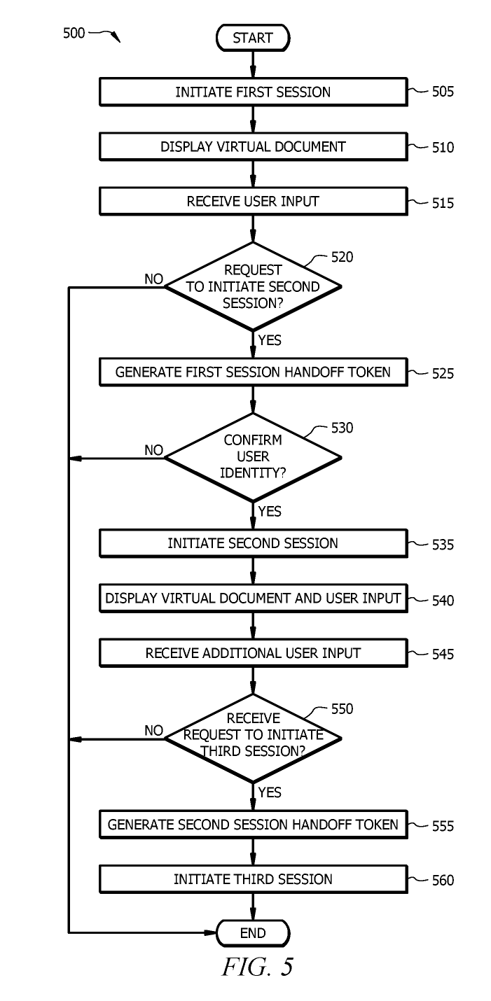

FIG. 5 is an example method 500 of a multiple user device handoff method performed by system 100. In some embodiments, user 102 utilizes system 100 to perform method 500. Method 500 beings at step 505 where user 102 initiates a first session. For example, user 102 may use a landing page to log into an online account to initiate a first online session. The method proceed to step 510 where user device 106 display a virtual document 127 to user 102. User 102 may request to initiate a request or transaction and user device 106 may display a virtual document 127 associated with the request or transaction in response to the request. User device 106 receives user input from user 102 at step 515. For example, user 102 may provide user input to complete virtual document 127.

System 100 determines whether user 102 requested to initiate a second session at step 520. For example, user 102 may request to switch to AR user device 110 to continue reviewing and/or completing virtual document 127. If user 102 does not request to initiate a second session, method 500 ends. Otherwise, the method proceeds to step 525 where server 118 generates a first handoff token 116. Handoff token 116 may include information for the status of the first session, such as a location that user 102 reached in the first session, user input provided by user 102 in the first session, and/or information provided to user 102 in the first session.

AR user device 110 may confirm user 102's identity at step 530. For example, AR user device 110 may receive biometric data for user 102 and compare it to predetermined biometric data for user 102. If AR user device 110 does not confirm user's 102 identity, method 500 ends. Otherwise, method 500 proceeds to step 535 where AR user device 110 receives session handoff token 116 to initiate a second session. AR user device 110 displays virtual document 127 and the user input at step 540. In some embodiments, the second session resumes where the first session ended. For example, the second session includes the first user input and facilitates displaying a portion of virtual document 127 that was displayed when user 102 requested to initiate a second session.

AR user device 110 receives additional user input at step 545. For example, user 102 may continue to complete virtual document 127 and/or provide any other type of input. At step 550, system 100 determines whether AR user device 110 received a request to initiate a third session. User 102 may initiate a third session to switch devices yet again (e.g., to switch to another AR user device 110 or to a device 106). If user 102 does not request to initiate a third session, method 500 ends. Otherwise method 500 proceeds to step 555 where server 118 generates a second session handoff token 116 that may include the location of the virtual document 127 that user 102 was viewing before requesting to initiate the third session, the user input, the additional user input, and/or any other suitable information. Server 118 communicates the second session handoff token 116 to an AR user device 110 or a user device 106 to initiate a third session at step 560 before method 500 ends.

Modifications, additions, or omissions may be made to method 400 depicted in FIG. 5. Method 500 may include more, fewer, or other steps. For example, steps may be performed in parallel or in any suitable order. While discussed as specific components completing the steps of method 500, any suitable any suitable component of system 100 may perform any step of method 500.

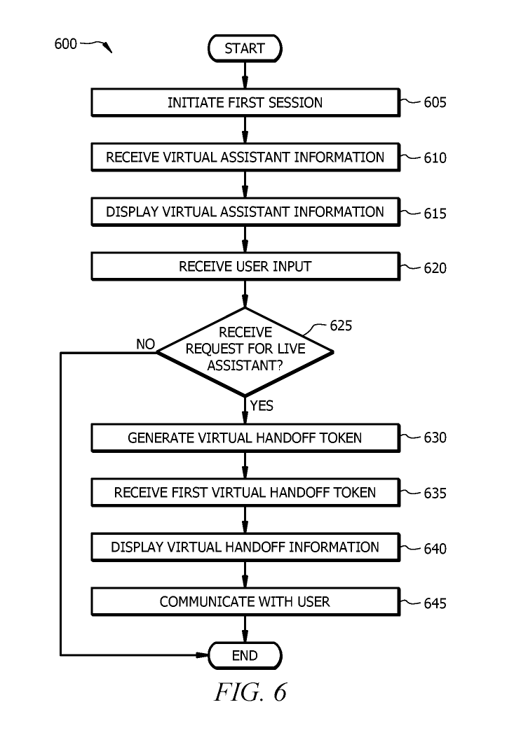

FIG. 6 is an example method 600 of an assistant handoff method performed by system 100. In some embodiments, user 102 utilizes system 100 to perform method 600. Method 600 begins at step 605 where user 102 initiates a first session. User 102 may initiate displaying a virtual document 127 in the first session. User 102 may receive virtual assistant information 128 from server 118 at step 610. Virtual assistant information 128 may include document overview information indicating a purpose of virtual document 127. For example, document overview information may indicate that virtual document is a loan application and provide background information for the loan application. Virtual assistant information 128 may include input information that includes instructions for completing a virtual document 127 when virtual document 127 requires or otherwise accepts user input. AR user device 110 and/or user device 106 displays virtual assistant information to user 102 at step 615. For example, an AR user device 110 may display virtual assistant 210. At step 620, server 118 receives user input from user 102. The user input may be input to complete virtual document 127.

System 100 determines whether it receives a request to initiate a second session that includes live assistant 104 at step 625. If user 102 do not request a live assistant 104, method 600 ends. Otherwise, method 600 proceeds to step 630 where server 118 generates virtual handoff token 114. As discussed, virtual handoff token 115 includes virtual handoff information 128 that may include virtual document 127, virtual assistant information 128 displayed to user 102, the user input, a location of the virtual document 127 that includes a portion of the virtual document 127 displayed to user 102 when user 102 requested live assistant 104 and/or any other suitable type of information.

Server 118 communicates virtual handoff token 114 to a second device associated with live assistant 104 at step 640. The second device may be user device 106c and/or AR user device 110c. User device 106c and/or AR user device 110c display information from virtual handoff token to live assistant 104. Live assistant 104 communicates with user 102 at step 645. For example, live assistant may answer questions posed by user 102, and/or help user 102 complete virtual document 102. In some embodiments, user device 106c and/or AR user device 110c may have a microphone and live assistant 104 may communicate with user 102 via the microphone.

Modifications, additions, or omissions may be made to method 600 depicted in FIG. 6. Method 600 may include more, fewer, or other steps. For example, steps may be performed in parallel or in any suitable order. While discussed as specific components completing the steps of method 600, any suitable any suitable component of system 100 may perform any step of method 600.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

1. An augmented reality system comprising:
a first user device for a user configured to:
display a virtual document during a first session;
receive user input from the user for the virtual document; and
receive a request from the user to initiate a second session on an augmented reality user device, wherein the second session is a continuation of the first session;
a server communicatively coupled to the first user device that stores session handoff information, the session handoff information comprising:
the user input; and
location information associated with a location of the virtual document, the location information indicating a portion of the virtual document that the first user device displayed at a time that the first user device received the request to initiate the second session;
the server configured to:
receive the request to initiate the second session;
generate a first session handoff token in response to the request, the first session handoff token comprising the session handoff information; and
an augmented reality user device communicatively coupled to the server, the augmented reality user device comprising:
a network interface configured to receive the first session handoff token to initiate the second session; and
a display configured to overlay the virtual document on a tangible object in real-time based at least in part on the first session handoff token, wherein the virtual document includes the user input and the display displays the information associated with the virtual document.

2. The augmented reality system of claim 1, wherein the augmented reality user device further comprises a physical identification verification engine configured to:
receive biometric data for the user;
confirm the user's identity by comparing the received biometric data for the user to predetermined biometric data for the user;
generate an identification token indicating the user's identity confirmation; and
communicate the identification token to the server; and
the server further configured to communicate the first session handoff token to the augmented reality user device in response to receiving the identification token.

3. The augmented reality system of claim 2, wherein the first identification verification engine receives biometric data for the user using at least one of a retinal scanner, a fingerprint scanner, a voice recorder, and a first camera.

4. The augmented reality system of claim 1, wherein:
the network interface is further configured to:
receive additional user input from the user; and
communicate the additional user input to the server; and
the server is further configured to:
receive a request to initiate a third session using the user device;
generate a second session handoff token in response to the request, the second session handoff token comprising the additional user input from the user; and
communicate the second session handoff token to the user device.

5. The augmented reality system of claim 1, wherein the augmented reality user device displays a virtual assistant that includes virtual assistant information, wherein the virtual assistant information provides instructions to the user for providing the user input.

6. The augmented reality system of claim 1, wherein the virtual document is a virtual loan application.

7. The augmented reality system of claim 1, wherein the first user device is one of a mobile phone, a computer, a tablet computer, and a laptop computer.

8. A method comprising:
displaying, using a first user device, a virtual document during a first session;
receiving, by the first user device, user input from the user for the virtual document;
receiving, by the first user device, a request from the user to initiate a second session on an augmented reality user device, wherein the second session is a continuation of the first session;
storing, using a server session handoff information, the session handoff information comprising:
the user input; and
location information associated with a location of the virtual document, the location information indicating a portion of the virtual document that the first user device displayed at a time that the first user device received the request to initiate the second session;
receiving, by the server, the request to initiate the second session;
generating, using the server, a first session handoff token in response to the request, the first session handoff token comprising the session handoff information;
receiving, through a network interface of an augmented reality device, first session handoff token to initiate the second session; and
overlaying, using a display of the augmented reality device, the virtual document on a tangible object in real-time based at least in part on the first session handoff token, wherein the virtual document includes the user input and the display displays the information associated with the virtual document.

9. The method of claim 8, further comprising:
receiving biometric data for the user;
confirming the user's identity by comparing the received biometric data for the user to predetermined biometric data for the user;
generating an identification token indicating the user's identity confirmation;
communicating the identification token to the server; and
communicating the first session handoff token to the augmented reality user device in response to receiving the identification token.

10. The method of claim 9, further comprising receiving biometric data for the user using at least one of a retinal scanner, a fingerprint scanner, a voice recorder, and a first camera.

11. The method of claim 8, further comprising:
receiving, through the network interface, additional user input from the user;
communicating the additional user input to the server;
generating a second session handoff token in response to the request, the second session handoff token comprising the additional user input from the user; and
communicating the second session handoff token to the user device.

12. The method of claim 8, further comprising displaying a virtual assistant that includes virtual assistant information, wherein the virtual assistant information provides instructions to the user for providing the user input.

13. The method of claim 8, wherein the virtual document is a virtual loan application.

14. The method of claim 8, wherein the first user device is one of a mobile phone, a computer, a tablet computer, and a laptop computer.

15. An augmented reality user device comprising:
a network interface configured to receive a first session handoff token generated by a server in response to a request from a first user to initiate a second session on the augmented reality user device, the first session handoff token comprising session handoff information, the session handoff information comprising:
user input received by a first user device for the first user, the user input from the user for a virtual document displayed by the first user device during a first session; and
location information associated with a location of the virtual document, the location information indicating a portion of the virtual document that the first user device displayed at a time that the first user device received the request to initiate the second session; and
a display configured to overlay the virtual document on a tangible object in real-time based at least in part on the first session handoff token, wherein the virtual document includes the user input and the display displays the information associated with the virtual document.

16. The augmented reality user device of claim 15, wherein the augmented reality user device further comprises a physical identification verification engine configured to:
receive biometric data for the user;
confirm the user's identity by comparing the received biometric data for the user to predetermined biometric data for the user;
generate an identification token indicating the user's identity confirmation; and
communicate the identification token to the server; and
the server further configured to communicate the first session handoff token to the augmented reality user device in response to receiving the identification token.

17. The augmented reality user device of claim 16, wherein the first identification verification engine receives biometric data for the user using at least one of a retinal scanner, a fingerprint scanner, a voice recorder, and a first camera.

18. The augmented reality user device of claim 15, wherein:
the network interface is further configured to:
receive additional user input from the user; and
communicate the additional user input to the server; and
the server is further configured to:
receive a request to initiate a third session using the user device;
generate a second session handoff token in response to the request, the second session handoff token comprising the additional user input from the user; and
communicate the second session handoff token to the user device.

19. The augmented reality user device of claim 15, wherein the augmented reality user device displays a virtual assistant that includes virtual assistant information, wherein the virtual assistant information provides instructions to the user for providing the user input.

20. The augmented reality user device of claim 15, wherein the virtual document is a virtual loan application.
